(19) United States
(12) Patent Application Publication
(10) Pub. No.: US 2006/0105843 A1
(43) Pub. Date: May 18, 2006

(54) Torsion protector for a start gear box of an engine of a radio control model

(76) Inventor: Wei Lin Chen, Taichung City (TW)

Correspondence Address: WEI LIN CHEN, P.O. Box 63-150, Taichung City, TW

(21) Appl. No.: 11/005,517

(22) Filed: Dec. 7, 2004

(30) Foreign Application Priority Data
Nov. 12, 2004 (TW) 093218092

(51) Int. Cl. F16D 7/04

(52) U.S. Cl. 464/39

(57) ABSTRACT

A torsion protector for a start gear box of a radio control model includes a stopper securely sleeved on an input shaft that is connected to the start gear box. A resilient member is sleeved on the input shaft and abuts the stopper. A resistant axle seat is movably sleeved on the input shaft and abuts resilient such that the resilient member is pre-compressively mounted between the resistant axle seat and the stopper. A drive axle seat is pivotally mounted to a distal end of the input shaft for driving the resistant axle seat. The drive axle selectively pushes the resistant axle seat to make the resistant axle seat be disengaged from the input shaft for protecting the start gear box when a counterforce from the input shaft is greater than a restitution force of the resilient member.

### BACKGROUND OF THE INVENTION

1. Field of the Invention

The present invention relates to torsion protector, and more particularly to a torsion protector for a start gear box of an engine of a radio control model.

2. Description of Related Art

A conventional engine of a radio control model in accordance with the prior art shown in FIG. 6 comprises a body (1) with a chamber (2) defined therein and a piston (3) reciprocally movably received in the chamber (2). A lower end of the piston (3) is connected to a T-shaped drive shaft (5) via a crank (4). The T-shaped drive shaft (5) has a free end longitudinally connected to a start gear box (6). A series of gears are disposed in the start gear box (6) for driving the T-shaped drive shaft (5). An input shaft (6A) rotatably extends from the start gear box (6) for driving the series of gears via an extra power source.

The fuel will be continually pumped for several seconds and slowly enter the carburetor of the engine when starting the engine. Consequently, engine may be locked when the fuel overly enter the carburetor due to a careless operation. Then, the user must immediately stop operating the gear box and detach the spark for draining the overflowed fuel to make the engine be unlocked for next operation.

However, the newcomer usually has not enough experience to make a correct judgement when the engine is locked. As a result, a high torsion is caused sue to a forced operation and the high torsion may break the series of gear in the start gear box.

The present invention has arisen to mitigate and/or obviate the disadvantages of the conventional start gear box of an engine of a radio control model.

### SUMMARY OF THE INVENTION

The main objective of the present invention is to provide a torsion protector for a start gear box of an engine of a radio control model for protecting a series of gears in the start gear box from being broken due to a high torsion.

To achieve the objective, the torsion protector in accordance with the present invention comprises a stopper securely sleeved on an input shaft that is connected to the start gear box. A resilient member is sleeved on the input shaft and abuts the stopper. A resistant axle seat is movably sleeved on the input shaft and abuts resilient such that the resilient member is pre-compressively mounted between the resistant axle seat and the stopper. A drive axle seat is pivotally mounted to a distal end of the input shaft for driving the resistant axle seat. The drive axle selectively pushes the resistant axle seat to make the resistant axle seat be disengaged from the input shaft for protecting the start gear box when a counterforce from the input shaft is greater than a restitution force of the resilient member.

Further benefits and advantages of the present invention will become apparent after a careful reading of the detailed description with appropriate reference to the accompanying drawings.

### BRIEF DESCRIPTION OF THE DRAWINGS

FIG. 1 is an exploded perspective view of a torsion protector for a start gear box of an engine of a radio control model in accordance with the present invention;

FIG. 2 is a perspective schematic view of a torsion protector for a start gear box of an engine of a radio control model in accordance with the present invention;

FIG. 3 is a partially cross-sectional view of the protector of the present invention;

FIG. 4 is a cross-sectional view of the protector of the present invention when the engine is unlocked;

FIG. 5 is a cross-sectional view of the protector of the present invention when the engine is locked; and

FIG. 6 is a side plan view of a conventional engine of a radio control model in partial cross-section in accordance with the prior art.

### DETAILED DESCRIPTION OF THE INVENTION

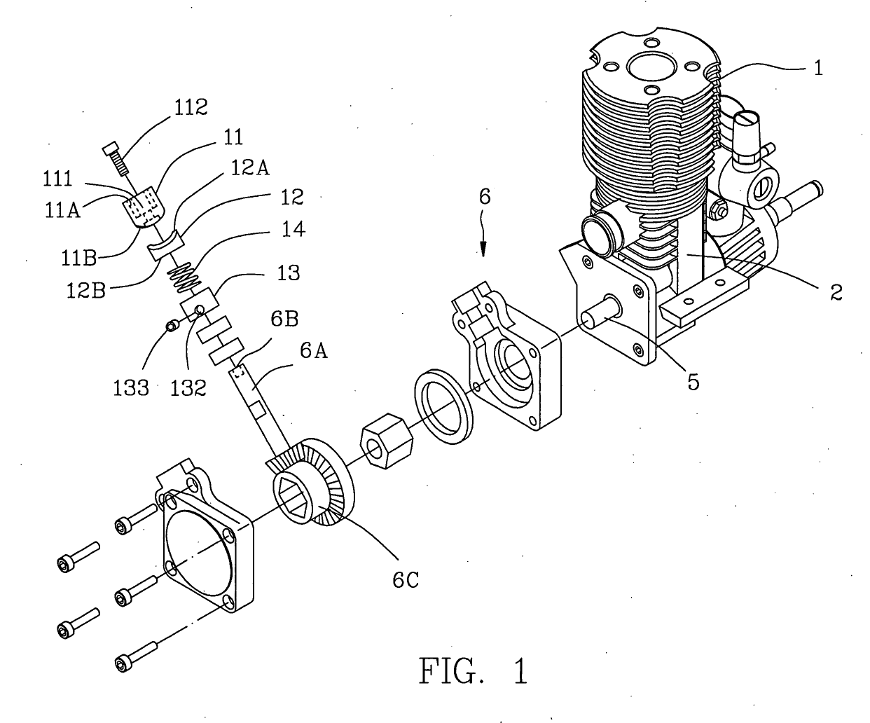

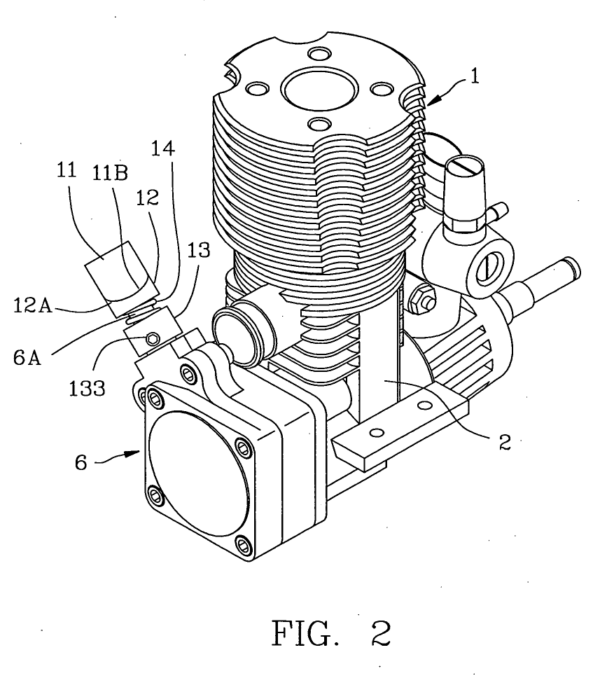

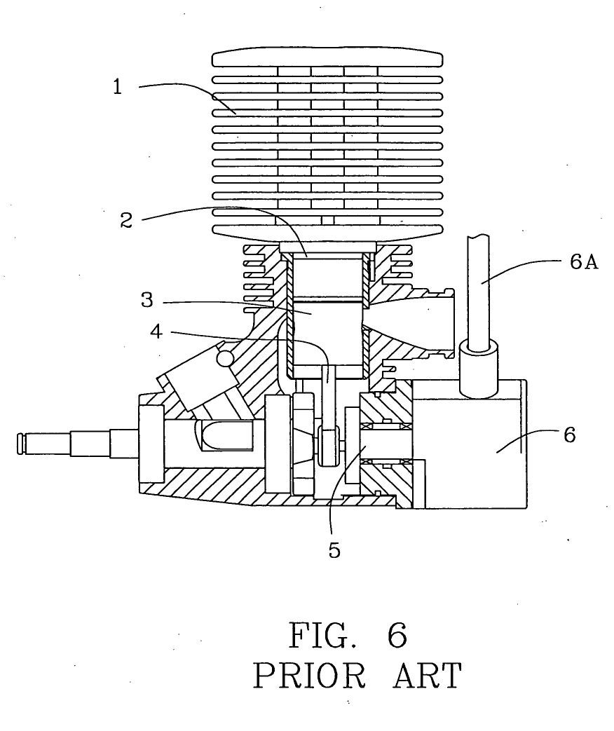

Referring to the drawings and initially to FIGS. 1, 2 and 6, a torsion protector for a start gear box of an engine of a radio control model in accordance with the present invention is longitudinally mounted to an input shaft (6A) of the start gear box (6) of the conventional engine of a radio control model as described above. The protector (10) of the present invention comprises a stopper (13), a resilient member (14), a resistant axle seat (12) and a drive axle seat (11) sequentially mounted to a free end of the input shaft (6A).

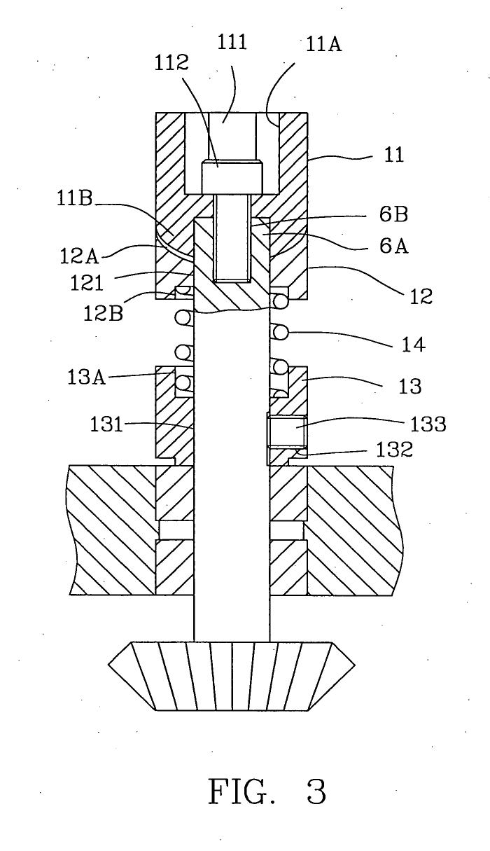

Further with reference to FIG. 3, the stopper (13) is securely sleeved on the input shaft (6A) and has a through hole (131) centrally defined therein for receiving the input shaft (6A). A threaded hole (132) is laterally defined in the stopper (13) and communicates with the through hole (131). A first locking member (133) is screwed into the threaded hole (132) and securely abuts an outer periphery of the input shaft (6A) to hold the stopper (13) in place. A first recess (13A) is longitudinally defined in the stopper (13) opposite to the start gear box (6). In the preferred embodiment of the present invention, the resilient member (14) is a spring and pre-compressively mounted between the resistant axle seat (12) and the stopper (13). The resilient member (14) has a first end received in the first recess (13A) and a second end opposite to the first end of the resilient member (14).

The resistant axle seat (12) is movably sleeved on the input shaft (6A) and selective disengaged from the input shaft (6A). A second through hole (121) is centrally defined in the resistant seat (12) for receiving the input shaft (6A). A second recess (12B) is longitudinally defined in the resistant axle seat (12) for receiving the second end of the resilient member (14). A first compatible portion (12A) is formed on a distal face for the resistant axle seat (12) opposite to the second recess (12B) of the resistant axle seat (12).

The drive axle seat (11) is pivotally mounted to a distal end of the input shaft (6A). A sunken hole (111) is centrally defined in and extends through the drive axle seat (11). A bolt (112) pivotally extends through the sunken hole (111) and is screwed into a threaded hole (6B), which is centrally defined in a distal end of the input shaft (6A), to prevent the drive axle seat (11) form detaching from the input shaft (6A). The sunken hole (111) has a polygonal portion used as a drive portion (11A) of the drive axle seat (11). A second compatible portion (11B) is formed on a bottom of the drive axle seat (11) and corresponds to the first compatible portion (12A). The second compatible portion (11B) and the first compatible portion (12A) complementarily correspond to each other. In the preferred embodiment of the present invention, the second compatible portion (11B) has an inverted V-shape. The first compatible portion (12A) and the second compatible portion (11B) abut each other and a preset torsion is formed between the first compatible portion (12A) and the second compatible portion (11B) due to a restitution force of the resilient member (14).

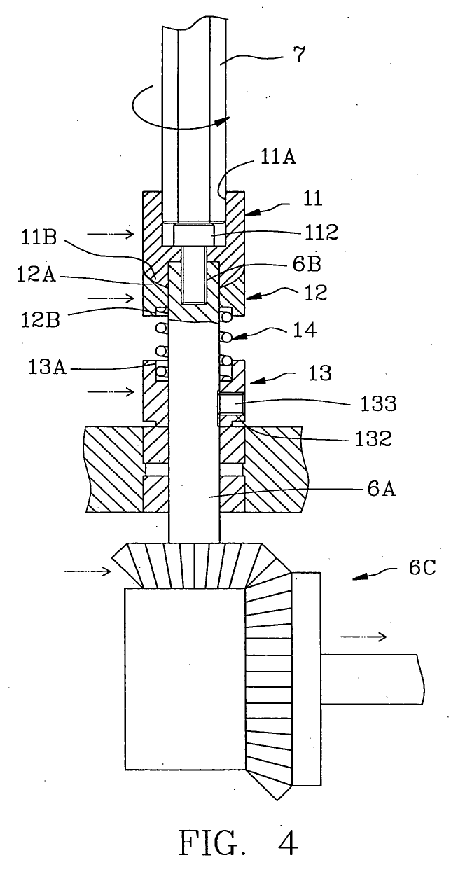

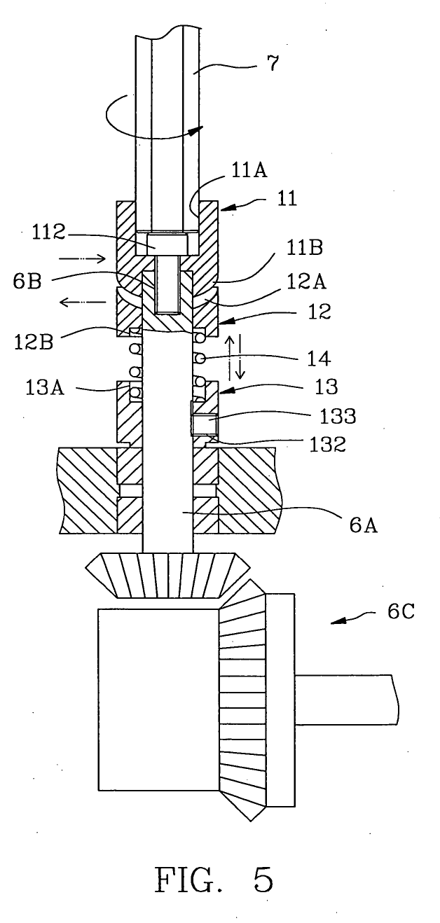

With reference FIG. 4, when starting the engine, a polygonal shaft (7) is partially inserted into the drive portion (11A) for driving the drive axle seat (11). As a result, the drive axle seat (11) sequentially the resistant axle seat (12) the input shaft (6A) for rotating the series of gears (6C) in the start gear box (6) to start the engine when the series of gears (6C) is unlocked. With reference to FIG. 5, a polygonal shaft (7) is partially inserted into the drive portion (11A) for driving the drive axle seat (11). The drive axle seat (11) pushes the resistant axle seat (12) toward the start gear box (6) due to the first and second compatible portions (12A, 11B) to make the resistant axle seat (12) be disengaged from the input shaft (6A) when the series of gears (6C) is locked and the counterforce from the locked series of gears (6C) is greater than the resilient force of the resilient member (14). As a result, the drive axle seat (11) is idly rotated for achieving a purpose of protecting the series of gears (6C) in the start gear box (6).

As described above, the idly rotated drive axle seat (11) reminds the operator to immediately stop operating the start gear box (6) for protecting the series of gears (6C) from being broken and detach the spark for draining the overflowed fuel to make the engine be unlocked for next operation.

Although the invention has been explained in relation to its preferred embodiment, it is to be understood that many other possible modifications and variations can be made without departing from the spirit and scope of the invention as hereinafter claimed.

What is claimed is:

1. A torsion protector for a start gear box of an engine of a radio control model, comprising:
a stopper adapted to be securely sleeved on an input shaft that is connected to a start gear box;
a resilient member adapted to be sleeved on the input shaft and having a first end abutting the stopper;
a resistant axle seat adapted to be movably sleeved on the input shaft and abutting a second end of the resilient such that the resilient member is pre-compressively mounted between the resistant axle seat and the stopper, the resistant axle seat adapted to be selectively disengaged from the input shaft; and
a drive axle seat adapted to be pivotally mounted to a distal end of the input shaft for driving the resistant axle seat, the drive axle selectively pushing the resistant axle seat to make the resistant axle seat be disengaged from the input shaft for protecting the start gear box when a counterforce from the input shaft is greater than a restitution force of the resilient member.

2. The torsion protector as claimed in claim 1, wherein the resistant axle seat comprises a first compatible portion form on a top thereof and the drive axle seat comprises a second compatible portion form on a bottom of the drive axle seat, the first compatible portion and the second compatible portion complementarily corresponding to each other.

3. The torsion protector as claimed in claim 1, wherein the stopper comprises a first recess defined to receive the first end of the resilient and the resistant axle seat comprises a second recess defined to receive the second end of the resilient.

4. The torsion protector as claimed in claim 1, wherein the resilient member is a spring.

5. The torsion protector as claimed in claim 2, wherein the second compatible portion has an inverted V-shaped.

6. The torsion protector as claimed in claim 2, wherein the stopper comprises a first recess defined to receive the first end of the resilient member and the resistant axle seat comprises a second recess defined to receive the second end of the resilient member.

7. The torsion protector as claimed in claim 3, wherein the resilient member is a spring.

8. The torsion protector as claimed in claim 6, wherein the resilient member is a spring.
